(19) United States
(12) Patent Application Publication
(10) Pub. No.: US 2020/0052908 A1
(43) Pub. Date: Feb. 13, 2020

(54) METHOD AND SYSTEM FOR MANAGING PUBLIC-KEY CLIENT CERTIFICATES

(71) Applicant: Access Layers Ltd., Herzelia (IL)

(72) Inventors: Juda THITRON, Tel Aviv (IL); Ofer Amitai, Even Yhuda (IL)

(73) Assignee: Access Layers Ltd., Herzelia (IL)

(21) Appl. No.: 16/535,900

(22) Filed: Aug. 8, 2019

Related U.S. Application Data
(60) Provisional application No. 62/716,428, filed on Aug. 9, 2018.

(51) Int. Cl. H04L 9/32; H04L 29/06

(52) U.S. Cl. CPC H04L 9/3268; H04L 63/10; H04L 63/20

(57) ABSTRACT

A system and a method of managing public-key client certificates by at least one processor, including: storing a compliance policy, including one or more rules; continuously monitoring one or more compliance parameters associated with at least one client computer; receiving a certificate request from the at least one client computer to access a computational resource; if the monitored compliance parameters do not comply with at least one rule of the compliance policy, then responding to the certificate request by refusing to grant a certificate to the at least one client computer; and if the monitored compliance parameters comply with the rules of the compliance policy, then responding to the certificate request by granting a policy-based certificate to the at least one client computer.

### CROSS-REFERENCE TO RELATED APPLICATION

This application claims the benefit of U.S. Provisional Patent Application No. 62/716,428, filed Aug. 9, 2018, the contents of which are incorporated by reference in its entirety.

### FIELD OF THE INVENTION

The present invention relates generally to the field of computer-access security. More specifically, the present invention relates to managing public-key client certificates.

### BACKGROUND OF THE INVENTION

State of the art applications and network protocols commonly use client certificates, also referred to as public-key certificates, as authentication factors to be presented by an endpoint (e.g., a client computer) as a part of authentication process. Such client certificates are commonly issued and deployed on endpoint systems through a process of enrollment, conducted by dedicated a software system, commonly referred to as Public Key Infrastructure (PKI) services.

Commercially available PKIs may commonly issue client certificates to endpoints without validating a status of compliance of the requesting endpoints to a policy of risk factors. These risk factors may relate to any type of computer-security policy (e.g., a governance policy, a compliance policy, a cyber-security policy, etc.) and may change dynamically over time.

Moreover, once a client certificate has been issued and deployed on a designated endpoint, a commercially available PKI system may not manage the certificate's life cycle based on a security policy or risk assessments. Consequently, endpoints or client computers that have been compromised or have moved out of compliance may continue to carry valid public-key certificates and may continue to access computational resources such as databases and corporate servers in an unhindered manner.

Accordingly, a system and a method for dynamically and continuously managing the validity of policy-based client public key certificates is desired.

### SUMMARY OF THE INVENTION

Some embodiments of the present invention may include a system for managing public-key client certificates.

An embodiment of the present invention may include a certificate server configured to: store a compliance policy that may include one or more rules; continuously monitor one or more parameters of governance associated with a client computer requiring access to a computational resource; continuously monitor one or more parameters of cyber-security associated with the client computer; receive a certificate request from the client computer to access the computational resource; if the monitored parameters do not comply with at least one rule of the compliance policy, then respond to the certificate request by refusing to grant a certificate to the client computer; and if the monitored parameters comply with the rules of the compliance policy, then respond to the certificate request by granting a policy-based certificate to the client computer.

The term ‘comply’ may be used herein to refer to adherence or fulfilment of a monitored parameter to a compliance rule or to a rule of a compliance policy (e.g., a compliance parameter having a value that may be within a predefined range, equal to a predefined permitted value, etc.). Compliance as referred to herein may relate to adherence to a rule of a compliance policy at a time of sampling or monitoring of the value of the compliance parameter. Alternatively, or additionally, compliance as referred to herein may relate to a history of adherence to a rule of a compliance policy (e.g., over a period of time) according to context, as elaborated in the description and examples herein.

An embodiment of the system may further include an authenticating entity, configured to authenticate the client computer's policy-based certificate as known in the art, to enable access of the client computer to the required computational resource.

According to some embodiments, the policy-based certificate may be time-limited.

If the continuously monitored parameters do not comply with at least one rule of the compliance policy after a policy-based certificate has been granted to the client computer, the certificate server may be configured to revoke a validity of the policy-based certificate in real-time.

If the continuously monitored parameters comply with rules of the compliance policy after a policy-based certificate has been revoked, the certificate server may be configured to restore the validity of the policy-based certificate in real time.

According to some embodiments, the client computer may include: a certificate store, configured to maintain at least one certificate granted by the certificate server; and a client authentication module or service configured to present a certificate from the certificate store to the authenticating entity in order to gain access to the computational resource.

According to some embodiments, the client computer may further include an agent module, configured to: gather data relating to the plurality of governance policy parameters associated with the client computer; gather data relating to the plurality of cyber-security parameters associated with the client computer; and continuously propagate the gathered data to the certificate server for monitoring.

According to some embodiments, the agent module may be further configured to perform at least one of: receive a granted, time-limited certificate from the certificate server, and store it in the certificate store; receive a revocation message from the certificate server and revoke a validity of a respective certificate in the certificate store; receive a revocation message from the certificate server and remove a respective certificate from the certificate store; receive a revalidation message from the certificate server and revalidate a respective, previously revoked validity of a certificate in the certificate store; and revoke a validity of a policy-based certificate according the certificate's time limitation.

The authenticating entity may be one of: an authenticating service, an application service and a network protocol.

The authenticating entity may be configured to enable access of the client computer to the required computational resource according to the validity of the policy-based certificate.

The parameters of governance may include at least one of: a type of the client computer, the client computer's geo-location, a version of a hardware installed therein, a version of a software installed therein, data relating to previous usage of the client computer, a profile of a current user of the client computer, a role of a current user of the client computer and an owner of the client computer.

The parameters of cyber-security may include at least one of: a known vulnerability of the client computer, a known cyber threat, an insecure configuration of the client computer, a malicious software installed on the client computer and a protocol used by the client computer.

Some embodiments of the present invention may include a method of managing public-key client certificates by at least one processor. An embodiment may include: receiving, from a client computer, a request to access a computational resource; storing, by a certificate server, a compliance policy, including one or more rules; continuously monitoring one or more parameters of governance associated with the client computer; continuously monitoring one or more parameters of cyber-security associated with the client computer; receiving a certificate request from the client computer to access the computational resource; if the monitored parameters do not comply with at least one rule of the compliance policy, then responding to the certificate request by refusing to grant a certificate to the client computer; if the monitored parameters comply with the rules of the compliance policy, then responding to the certificate request by granting a policy-based certificate to the client computer; and authenticating the client computer's policy-based certificate by an authenticating entity, to enable access of the client computer to the required computational resource.

Some embodiments of the present invention may include a certificate server configured to: store a compliance policy that may include one or more rules (e.g., compliance rules); continuously monitor one or more compliance parameters associated with at least one client computer; receive a certificate request from the at least one client computer to access a computational resource; if the monitored compliance parameters do not comply with at least one rule of the compliance policy, then respond to the certificate request by refusing to grant a certificate to the at least one client computer; and if the monitored compliance parameters comply with the rules of the compliance policy, then respond to the certificate request by granting a policy-based certificate to the at least one client computer.

According to some embodiments of the invention, the certificate server may be configured to: if one or more monitored compliance parameters do not comply with at least one rule of the compliance policy after a policy-based certificate has been granted to the client computer, then revoke a validity of the policy-based certificate in real-time or near real time.

According to some embodiments of the invention, the certificate server may be configured to: if the monitored compliance parameters comply with rules of the compliance policy after a policy-based certificate has been revoked, then restore the validity of the policy-based certificate in real time or near real time.

According to some embodiments of the invention, the compliance policy may include, for example: a governance policy, associated with one or more governance compliance parameters; a cyber-security policy, associated with one or more cyber-security compliance parameters; a time-based policy, associated with one or more time-based compliance parameters; and an implementor-specific policy associated with one or more implementor compliance parameters.

According to some embodiments of the invention, one or more time-based compliance parameters may, for example, be time limits (e.g., start time, end time, duration, etc.), adapted to restrict a validity of the policy-based certificate to a time frame.

According to some embodiments of the invention, the governance compliance parameters may include, for example, a type of a client computer, the client computer's geo-location, a type of hardware that may be installed on the client computer, a version of a hardware that may be installed on the client computer, a software that may be installed on the client computer, a version of a software that may be installed on the client computer, a status of installation of software components on the client computer, data relating to previous usage of the client computer, a profile of a user of the client computer, a role of a user of the client computer (e.g., a role in an organization, such as an administrator, a role pertaining to the client computer such as a user), an identification (e.g., an identification number, a user name, etc.) of an owner of the client computer, an enrollment of the client computer in an organization domain (e.g., an authentication process and/or resource allocation vis a vis an organizational administrative system), a status of encryption of disk drivers of the client computer, a status of password protection (e.g., strong password, weak password, etc.) of the client computer, a status of connection to peripheral devices (e.g., whether external devices such as flash memory devices are connected to a port or interface of the client computer), and a status of a limitation to a number of open communication ports.

According to some embodiments of the invention, cyber-security compliance parameters may include, for example: a known vulnerability of a client computer (e.g., connectivity to potentially compromised computing devices, such as computers from beyond a domain of an organization), a status of a known cyber threat, an insecure configuration of the client computer (e.g., lack of cyber-security protection definitions, such as enablement of connectivity to communication ports through a firewall system, lack of an antivirus installation, etc.), a malicious software installed on the client computer, a protocol used by the client computer (e.g., a torrent download protocol, a data upload protocol), a communication with a compromised entity, a status of received network errors, a status of network activity, and a rogue process executed by the client computer (e.g., a process that may spawn child processes that may initiate communication with additional computing entities).

According to some embodiments of the invention, the certificate server may be associated with an authenticating entity that may be configured to authenticate the at least one client computer's policy-based certificate, so as to enable access of the at least one client computer to the computational resource.

According to some embodiments of the invention, the certificate server may be associated with at least one agent module that may, in turn, be associated with or installed or integrated into at least one respective client computer. The at least one agent module may be configured to gather data pertaining to one or more compliance parameters of the at least one client computer. For example, the agent may be configured to gather information (e.g., an address) regarding communication of the client computer with other computing devices. In another example, the agent may be configured to gather information regarding actions that may have been performed (e.g., by a user, by an application, etc.) on the client computer, such as un-installation of an antivirus program, changing of a password, etc.

Additionally, or alternatively, the agent module may continuously (e.g., repetitively over time) propagate the gathered data to the certificate server for monitoring.

According to some embodiments of the invention, the certificate server may be configured to determine if the monitored compliance parameters comply with rules of compliance policy according to a risk score that may include a weighted sum of individual compliance test results, as elaborated herein.

Some embodiments of the invention may include a system for managing public-key client certificates. Some embodiments of the system may include a certificate server and an authenticating entity. The certificate server may be configured to: store a compliance policy; include one or more rules; continuously monitor one or more compliance parameters associated with at least one client computer; receive a certificate request from the at least one client computer to access a computational resource; if the monitored compliance parameters do not comply with at least one rule of the compliance policy, then respond to the certificate request by refusing to grant a certificate to the at least one client computer; and if the monitored compliance parameters comply with the rules of the compliance policy, then respond to the certificate request by granting a policy-based certificate to the at least one client computer. The authenticating entity may be configured to authenticate the client computer's policy-based certificate, so as to enable access of the client computer to the computational resource.

According to some embodiments of the invention, the authenticating entity may include, for example: an authenticating service, an application service and a network protocol. The authenticating entity may be configured to enable access of the at least one client computer to the computational resource based on validity of the policy-based certificate. For example, if a policy-based certificate is invalidated, as elaborated herein, the authenticating entity disallow access of the at least one client computer to the computational resource. In another example, if a policy-based certificate is granted, and/or if a validity of the certificate is reinstated or re-validated, as elaborated herein, the authenticating entity may be configured to allow access of the at least one client computer to the computational resource.

Some embodiments of the system may include at least one agent that may be associated with a respective at least one client computer, the agent configured to: gather data relating to one or more compliance parameters associated with the client computer; and continuously propagate the gathered data to the certificate server for monitoring.

According to some embodiments of the invention, the agent may be further configured to receive a policy-based certificate from the certificate server and store the policy-based certificate in a certificate store that may be associated with a respective client computer.

According to some embodiments of the invention, the agent may be further configured to perform at least one of: receive a revocation message from the certificate server and revoke a validity of a respective policy-based certificate in the certificate store; receive a revocation message from the certificate server and remove a respective policy-based certificate from the certificate store; receive a revalidation message from the certificate server and restore the validity of a respective policy-based certificate in the certificate store; and revoke a validity of a policy-based certificate according a policy-based certificate's time limitation.

Some embodiments of the invention may include a method of managing public-key client certificates by at least one processor. Some embodiments of the method may include: maintaining a compliance policy may include one or more rules; continuously monitoring one or more compliance parameters associated with at least one client computer; receiving a certificate request from the at least one client computer to access a computational resource; if the monitored compliance parameters do not comply with at least one rule of the compliance policy, then responding to the certificate request by refusing to grant a certificate to the at least one client computer; and if the monitored compliance parameters comply with the rules of the compliance policy, then responding to the certificate request by granting a policy-based certificate to the at least one client computer.

Some embodiments of the method may further include: if one or more monitored compliance parameters do not comply with at least one rule of the compliance policy after a policy-based certificate has been granted to the client computer, then revoking a validity of the policy-based certificate in real-time or near real time. Additionally, or alternatively, if the monitored compliance parameters comply with rules of the compliance policy after a policy-based certificate has been revoked, then restoring the validity of the policy-based certificate in real time or near real time.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram, depicting computing device which may be included within a system for management of public-key client certificates, according to some embodiments;

FIG. 2 is a block diagram, depicting a system for management of public-key client certificates, according to some embodiments;

FIG. 3 is a block diagram, depicting a system for management of public-key client certificates, according to some embodiments;

FIG. 4 is a flow diagram, depicting a method of managing public key certificates by one or more processors, according to some embodiments; and

FIG. 5 is a flow diagram, depicting another method of managing public key certificates by one or more processors, according to some embodiments

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

Some embodiments of the present invention disclose a method and a system for dynamically and continuously managing the validity of policy-based client public key certificates.

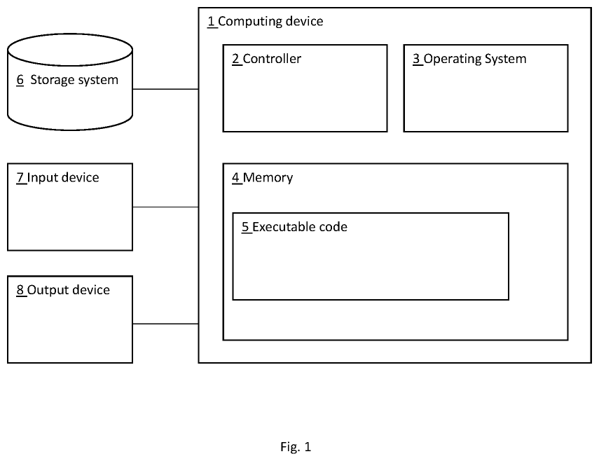

Reference is now made to FIG. 1, which is a block diagram depicting a computing device, which may be included within an embodiment of a system for managing public key certificates, according to some embodiments.

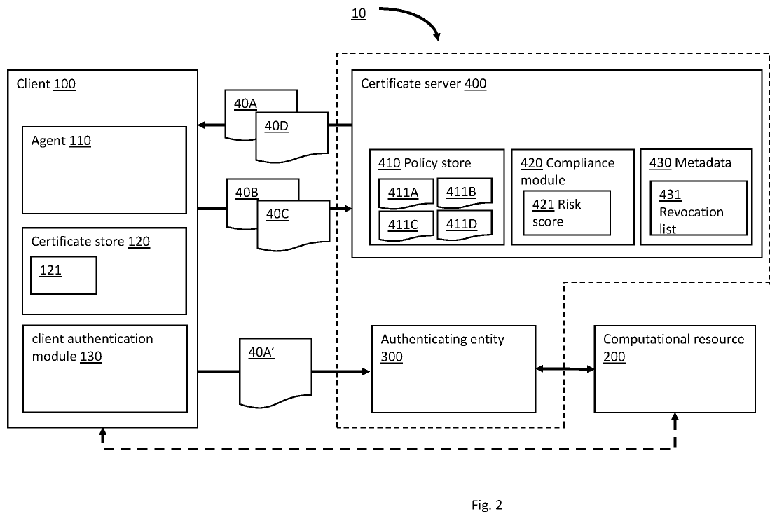

Computing device 1 may include a controller 2 that may be, for example, a central processing unit (CPU) processor, a chip or any suitable computing or computational device, an operating system 3, a memory 4, executable code 5, a storage system 6, input devices 7 and output devices 8. Controller 2 (or one or more controllers or processors, possibly across multiple units or devices) may be configured to carry out methods described herein, and/or to execute or act as the various modules, units, etc. More than one computing device 1 may be included in, and one or more computing devices 100 (FIG. 2) may act as the components of, a system according to embodiments of the invention.

Operating system 3 may be or may include any code segment (e.g., one similar to executable code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short-term memory unit, a long-term memory unit, or other suitable memory units or storage units. Memory 4 may be or may include a plurality of, possibly different memory units. Memory 4 may be a computer or processor non-transitory readable medium, or a computer non-transitory storage medium, e.g., a RAM.

Executable code 5 may be any executable code, e.g., an application, a program, a process, task or script. Executable code 5 may be executed by controller 2 possibly under control of operating system 3. For example, executable code 5 may be an application that manages public-key client certificates as further described herein. Although, for the sake of clarity, a single item of executable code 5 is shown in FIG. 1, a system according to some embodiments of the invention may include a plurality of executable code segments similar to executable code 5 that may be loaded into memory 4 and cause controller 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Content may be stored in storage system 6 and may be loaded from storage system 6 into memory 120 where it may be processed by controller 2. In some embodiments, some of the components shown in FIG. 1 may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components or systems, e.g., a detachable keyboard or keypad, a mouse and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., controllers similar to controller 2), a plurality of input units, a plurality of output units, a plurality of memory units, and a plurality of storage units.

Reference is now made to FIG. 2, which is a block diagram depicting a system 10 for managing public key certificates, according to some embodiments. System 10 may be configured to manage role-based and policy-based access of one or more client computing devices 100 to one or more computational resources 200.

Each of the one or more client device(s) 100 may be or may include, for example, a corporate endpoint device or a Bring Your Own Device (BYOD) computer, or other computing devices such as personal computers, smartphones, etc. Client device 100 may be implemented, for example, as a hardware module (e.g., computing device 1 of FIG. 1), and may include one or more processors or controllers (e.g., element 2 of FIG. 1), configured to require access to the one or more computational resources 200.

The one or more computational resources 200 may include, for example, a server (e.g., a corporate application server or resource server), a storage system, a service or a process. The one or more computational resources 200 may be implemented, for example as a hardware module (e.g., computing device 1 of FIG. 1), a software module (e.g., a service or a process executed on computing device 1 of FIG. 1) or any combination thereof.

As known in the art, the one or more computational resources 200 may be configured to receive at least one access request from a client device 100 and may grant such access upon reception of a valid client certificate as an authentication factor.

As shown in FIG. 2, system 10 may include a certificate server 400, configured to issue or generate a policy-based certificate 40A for at least one client device 100, to access a respective computational resource 200.

According to some embodiments, system 10 may further include an authenticating entity 300, associated with (e.g., in communication with) certificate server 400. Authenticating entity 300 may be configured to authenticate a client device's certificate (e.g., a policy-based certificate) 40A, to enable access of the client computer 100 to the required computational resource 200. For example, authenticating entity 300 may verify that the certificate has been issued and signed by the certificate server, verify that the current date and time is between a start time and an end time included in the certificate, etc., and enable client device 100 to access at least one data element stored on or associated with computational resource 200.

Additionally, or alternatively, authenticating entity 300 may be configured to enable access of at least one client computer 100 to computational resource based on validity of the policy-based certificate, as elaborated herein (e.g., in relation to table 1).

According to some embodiments, authenticating entity 300 may be implemented, for example, as one of: an authenticating service, an application service and a network protocol.

For example, authenticating entity 300 may be executed by one or more processors associated with the at least one computational resource 200. Computational resource 200 may be a storage server, and authenticating entity 300 may be: (a) executed by a first computing device or server that may manage the storage; or (b) on a second computing device (e.g., a computer, server, etc.) that may be associated with (e.g., communicatively connected via a computer network connection) the first server.

According to some embodiments, various components of system 10 such as server 400 and authenticating entity 300 and other modules and entities discussed herein, may be or may include computing devices such as depicted in the example of FIG. 1. Additionally, or alternatively, system 10 may include one or more components (e.g., computational resource 200, agent module 110, certificate store 120 and/or client authentication module 130) that may be associated with or included or installed on additional computing devices (e.g., such as element 1 of FIG. 1), as elaborated herein.

According to some embodiments, certificate server 400 may store or maintain (e.g., on a storage device, such as element 6 of FIG. 1) at least one compliance policy 411 (e.g., 411A, 411B, 411C, 411D) may include one or more rules, which may dictate one or more conditions for granting a policy-based certificate, as elaborated herein.

Certificate server 400 may be communicatively connected (e.g., via a computer network such as the Internet) to at least one client 100 computing device. In some embodiments, certificate server 400 may be communicatively connected directly with client 100. Alternatively, certificate server 400 may be communicatively connected with client 100 via a respective agent module 110.

For example, client 100 may be associated with at least one agent module 110, which may, for example, be implemented as a software module or process and may be executed by a processor of client 100.

In another example, agent module 110 may be or may include a computing device (e.g., element 1 of FIG. 1) that may be separate from client device 100. Agent module 110 may be communicatively connected and/or associated with client device 100 via any type of appropriate computer communication (e.g., a local connection such as a Peripheral Component Interconnect Express (PCIE) bus and/or a remote connection such as an Ethernet or Internet connection).

According to some embodiments, agent 110 may provide or transmit to certificate server 400 at least one compliance parameter 40B data element pertaining to the respective client 100 computing device. For example, compliance parameter 40B may be or may include a value of one or more compliance parameters of client 100, as elaborated herein.

Additionally, or alternatively, client 100 computing device may be configured to send or transmit the at least one compliance parameter 40B (e.g., the at least on value of compliance parameter) to certificate server 400 directly (e.g., not via agent module 110).

Certificate server 400 may continuously monitor one or more compliance parameter 40B data elements associated with at least one client computer. For example, certificate server 400 may repetitively (e.g., every predefined time period and/or in reaction to an event such as reception of a compliance parameter 40B data element from client 100), over a period of time, examine the one or more compliance parameters 40B in view of the rules of the stored compliance policy 411.

Client 100 may send or transmit a certificate request 40C to certificate server 400. Certificate request 40C may, for example, include a request to provide or grant a policy-based certificate 40A to client 100, so as to enable client 100 to access one or more computational resources 200. Certificate server 400 may receive certificate request 40C and may select whether to grant or deny the requested certificate according to compliance policy 411.

For example, if one or more monitored compliance parameters 40B do not comply with at least one rule of the compliance policy 411, then certificate server 400 may respond to certificate request 40C by refusing to grant a certificate to the at least one client computer 100 or by not responding at all.

In a complementary manner, if monitored compliance parameter 40B data elements comply with the rules of the compliance policy 411, then certificate server 400 may respond to the certificate request by granting a policy-based certificate 40A to the at least one client computer 100.

As known in the art, client 100 may require access (e.g., a data read access, a data write access and the like, marked as a dashed arrow in FIG. 2) to computational resource 200. Computational resource 200 may subsequently initiate an authorization process. As part of the authorization process, client 100 may transmit or send a copy of policy-based certificate 40A (e.g., 40A′) to authenticating entity 300 so as to gain the required access to computational resource 200.

According to some embodiments, authenticating entity 300 is configured to authenticate the client computer's policy-based certificate, in order to enable access of the client computer to the computational resource.

In some embodiments, authenticating entity 300 may be implemented as a software module or process, and may be executed by a processor (e.g., element 2 of FIG. 1) of computational resource 200. Alternatively, authenticating entity 300 may be implemented as a software module, a hardware module or any combination thereof, and may be implemented on a computing device that may be separate from computational resource 200.

Certificate server 400 may include a policy storage module 410, which may be implemented, for example as a storage device (e.g., element 6 of FIG. 1). Policy storage module 410 may be configured to store one or more compliance policies 411 (e.g., elements 411A, 411B, 411C, 411D).

For example, the one or more compliance policies may include a governance policy, associated with one or more governance compliance parameters; a cyber-security policy, associated with one or more cyber-security compliance parameters; a time-based policy, associated with one or more time-based compliance parameters; and an implementor-specific policy, associated with one or more implementor compliance parameters.

One or more (e.g., each compliance policy 411 may be or may include a data structure (e.g., a table in a database) that may include one or more rules. The one or more rules may dictate a condition for granting a policy-based certificate in view of one or more compliance parameters, as elaborated herein.

The term “governance policy” may be used herein to refer to a policy that may be dictated, for example, by an organization, and may define terms for compliance of client computers that require access to computational resources (e.g., of the organization).

Policy storage module 410 may store one or more governance compliance policies 411A. The one or more governance compliance policies 411A may be or may include a data structure (e.g., a table) that may include one or more rules, dictating a condition for granting, denying, revoking and/or revalidating a certificate, in view of respective one or more governance compliance parameters 40B.

For example, the one or more governance compliance parameters 40B may include a version, a vendor and/or type of a client computer 100 (e.g., a desktop computer, a smartphone etc.). A respective rule of a governance policy 411A may be a restriction of a certificate to a specific type of a client computer 100 (e.g., deny a certificate from a smartphone computer, grant a certificate only to client devices of a list of authorized vendors, etc.).

In another example, the one or more governance compliance parameters 40B may include the client computer's geo-location. A respective rule of a governance policy 411A may be a restriction of a certificate to a specific geo-location.

In another example, the one or more governance compliance parameters 40B may be a type and/or version of a hardware module that may be installed on client computer 100 (e.g., a list of authorized network adapters). A respective rule of a governance policy 411A may be a restriction of a certificate to client computing devices that include the required hardware (e.g., deny certificates from clients that do not include the required type and/or version of hardware modules). Additional examples of governance compliance parameters 40B may include: a software and/or a version of a software installed on client computer 100 (e.g., whether client 100 is up-to-date with all patches for all applications and operating system (OS)); a status of installation of software components (e.g., whether the device may allow installation of software components and applications from unauthorized sources or only from organizational code stores, whether a compromised software has been found on a client device, etc.); data relating to previous usage of client computer 100; a profile of a user (e.g., a current user) of client computer 100; a role of a user (e.g., a current user) of client computer 100 (e.g., within an organization); an identification of an owner of client computer 100; enrollment of client 100 in an organization domain; a status of encryption of disk drivers of client 100 (e.g., whether the disk drivers of client 100 are encrypted); a status of password protection of client 100 (e.g., whether a strong password or other form of authentication is required in order to work on client 100; a status of connection to other devices, such as peripheral devices (e.g., external Universal Serial Bus (USB) sticks, printers, scanners and the like); and a status of a limitation to a number of open communication ports (e.g., whether client 100 enables a number of listeners beyond a predefined limitation).

Pertaining to the same example, respective examples of non-exhaustive governance rules that may be included in the one or more governance policy 411A may include, for example: a restriction on the types of client computers 100 (e.g., denial of certificates 40A to smartphones), a restriction of a geo-location (e.g., denial of a certificate 40A when client computer 100 is outside a predefined territory), a restriction of a role or a profile of a current user of client computer 100 (e.g., granting of a certificate according to a user's role in an organization), a restriction on the a status of password protection (e.g., granting of a certificate 40A only if client 100 is protected by a strong password), a restriction on the status of connection to peripheral devices (e.g., denial of a certificate 40A when client computer 100 is connected to a memory stick), etc. It may be appreciated by a person skilled in the art that additional rules for granting and/or denying a certificate 40A may be produced in view of the elaborated governance compliance parameters 40B.

According to some embodiments of the invention, policy storage module 410 may store one or more compliance policy elements that are cyber-security policies 411B. The one or more cyber-security policies may be or may include a data structure (e.g., a table) that may include one or more rules, dictating a condition for granting, denying, revoking and/or revalidating a certificate in view of one or more cyber-security compliance parameters 40B.

For example, the one or more compliance parameters 40B of cyber-security may include: a known vulnerability of the client computer, a status of a known cyber threat (e.g., whether client 100 has downloaded suspicious content from the Internet), an insecure configuration of client computer 100, malicious software that may be installed on client computer 100, a protocol that may be used by client computer 100, a communication with a compromised and/or malicious entity (e.g., a network address, a Uniform Resource Locator (URL), an Internet Protocol (IP) address, and the like), a status of received network errors (e.g., whether client 100 has received an abnormally large amount of Domain Name Server (DNS) errors), a status of network activity (e.g., whether client 100 has performed abnormal network operations, including for example: sending communication requests to an abnormally large number of destinations, creating an abnormally large amount of network traffic, performing a port scan of other devices on the network, etc.) and a rogue process that may be executed by client 100 (e.g., a process that may be parented by an unexpected process, a process that may unexpectedly spawn child processes, a process that may use unexpected network resources, a process that may perform access attempts to other elements on the network at an unexpected or unusual time and/or date, etc.).

Pertaining to the example of cyber-security compliance parameters 40B, respective non-exhaustive examples of rules that may be included in cyber-security policies 411B may include, for example: denying a certificate 40A to a client 100 that may be infected by a known cyber threat or malicious software, denying a certificate 40A to a client 100 that is configured in an insecure manner (such as not protected by a strong user password), denying a certificate 40A to a client 100 that is addressing or has historically addressed an untrusted, compromised and/or malicious entity (e.g., a compromised internet site), denying a certificate 40A to a client 100 that is using or that has historically used an untrusted communication protocol (e.g., a ‘torrent’ download protocol), and the like. It may be appreciated by a person skilled in the art that additional rules for granting and/or denying a certificate 40A may be produced in view of the elaborated cyber-security compliance parameters 40B.

According to some embodiments of the invention, policy storage module 410 may store one or more compliance policy elements that are time-based compliance policies 411C. The one or more time-based compliance policies 411C may be or may include a data structure (e.g., a table) that may include one or more rules, dictating a condition for granting, denying, revoking and/or revalidating a certificate in view of one or more time-based compliance parameters 40B.

For example, the one or more time-based compliance parameters 40B may include parameters of time limits, adapted to restrict a validity of the policy-based certificate to a time frame. For example, time-based compliance parameters 40B may include a certificate start time, a certificate end time and a certificate duration.

Pertaining to the example of time-based compliance parameters 40B, respective non-exhaustive examples of rules that may be included in cyber-security policies 411B may include, for example: granting a certificate 40A that may be valid only within a timeframe between a certificate start time and a certificate end time, granting a certificate 40A that may be valid only within a timeframe between an initial time (e.g., a time of granting, a time of authentication of client 100 vis a vis authenticating entity 300, etc.) and the certificate end time, and granting a certificate 40A that may be valid only in a timeframe between an initial time and throughout a certificate duration time.

According to some embodiments of the invention, policy storage module 410 may store one or more compliance policy elements that are implementor-specific compliance policies 411D. The one or more implementor-specific compliance policies 411D may be or may include a data structure (e.g., a table) that may include one or more rules, dictating a condition for granting, denying, revoking and/or revalidating a certificate in view of one or more implementor compliance parameters 40B. The one or more implementor compliance parameters 40B may include parameters that may be defined by a specific implementation of an embodiment of the invention (e.g., by an administrator in an organization that may prefer to impose a specific policy that may be unique to the respective organization and/or a part thereof).

According to some embodiments, certificate server 400 may include a compliance module 420, configured to continuously or periodically receive one or more compliance-policy parameters 40B (for example: governance compliance parameters, cyber-security compliance parameters, time-based compliance parameters and implementor compliance parameters) from client computer 100, as explained herein. Compliance module 420 may continuously or periodically monitor the one or more received compliance-policy parameters, to continuously ascertain whether client 100 is compliant with or in agreement with the rules of the at least one compliance policy, as elaborated herein.

The term “continuously” may be used herein to refer to performance of an action repeatedly or periodically (e.g., many times a minute, many times a second, once a second, etc.) and/or in response to a triggering event (e.g., in response to receiving a data element from client 100).

Compliance module 420 may receive a certificate request 40C from client 100 to access computational resource 200 (e.g., read data from or write data to computational resource 200) and may determine whether to grant or deny the request according to the continuous monitoring of compliance parameters, as elaborated herein.

For example, if the monitored parameters 40B do not comply with or meet the requirements of at least one rule of the compliance policy 411 (e.g., when client computer 100 is infected by a known cyber threat), then certificate server 400 (e.g., compliance module 420 of certificate server 400) may be configured to respond to the certificate request 40C by denying a certificate from the requesting client computer.

Alternatively, if the monitored parameters 40B do comply or fit with the rules of the compliance policy 411 (e.g., client 100 is protected by a strong password, etc.), then certificate server 400 (e.g., compliance module 420 of certificate server 400) may be configured to respond to the certificate request 40C by granting a policy-based certificate to the client computer 100. Client computer 100 may consequently propagate or send the granted public key certificate (or a copy thereof 40A′) to an appropriate authentication entity 300, to gain access to a computational resource 200.

In some embodiments, certificate server 400 may determine if monitored compliance parameters 40B sufficiently comply with the rules of the compliance policy 411 and/or whether to grant or deny the requested certificate according to risk score 421, which may include a weighted sum of individual compliance test results.

For example, an individual test result may include an indication (e.g., a binary indication) of whether a specific compliance parameter complies with a respective compliance rule of a compliance policy 411 (e.g., ‘1’ representing compliance, ‘0’ representing noncompliance). Additionally, or alternatively, an individual test result may include an indication of an extent to which a compliance parameter complies with a respective compliance rule of a compliance policy 411 (e.g., a high value for a client that is protected by a strong password, a small value for a client that is protected by a weak password, and an intermediate value for a client that is protected by an intermediate password).

Certificate server 400 (e.g., compliance module 420) may produce a risk score 421 according to at least one of: one or more compliance parameters and one or more compliance rules of a compliance policy (e.g., each having a different weight or priority) to produce an overall risk assessment or score 421 of a risk, or “health” of a specific client 100. Compliance module 420 may calculate a risk score 421 that may be a weighted sum of a plurality of compliance individual test results.

Certificate server 400 may associate risk score 421 with at least one of an identification of a client 100 and an identification of a computational resource 200.

Certificate server 400 may then determine whether to grant or deny a request for a certificate from client 100 to computational resource 200 according to the overall risk assessment (e.g., as manifested in the respective risk score).

For example, compliance module 420 may determine that: (a) a client 100 does not comply with a first rule of a compliance policy 411 that may be assigned a first, low weight or priority; and (b): the client does comply with a second rule of a compliance policy 411 that may be assigned a second, high weight or priority. Compliance module 420 may thus assign an overall risk score 421 value that may exceed a predefined threshold value, and may thus determine that client 100 may be granted a certificate although it may not comply with all rules of compliance policies 411.

Additionally, as elaborated herein, certificate server 400 may dynamically determine whether to revoke or reinstate a validity of a certificate following a change in the risk assessment or score 421. For example, compliance module 420 may periodically reevaluate a risk score 421 pertaining to a specific client 100 and may revoke a certificate if score 421 falls below a predefined threshold. In a complementary manner, compliance module 420 may periodically reevaluate a risk score 421 pertaining to a specific client 100 and may reinstate a revoked certificate if score 421 surpasses a predefined threshold.

As elaborated herein (e.g., in relation to time-based compliance policy 411C), in some embodiments, policy-based certificate 40A may be time-limited to a specific time frame, for example such that a validity of the certificate may expire at a predefined time after it has been issued by certificate server 400. In such conditions, access to computational resource 200 by using the invalidated certificate as an access factor may be denied by authentication entity 300.

Thus, attribution of a time limit to the certificate may time-wise constrain the access of a client 100 to a computational resource 200 in the event that client 100 has been compromised (e.g., fallen out of compliance according to a compliance policy). For example, if the analysis of compliance parameters is disrupted (e.g., by a malicious software that has been installed on client computer 100 in a manner that could not be detected by system 10), the compromised client 100 would only be able to obtain access to computational resource 200 for a predefined, limited duration and/or a predefined number of times (e.g., a single access).

According to some embodiments, if one or more continuously and/or repeatedly monitored compliance parameters 40B do not comply with at least one rule of a compliance policy 411 after a policy-based certificate 40A has already been granted to client 100, certificate server 400 (e.g., compliance module 420 of certificate server 400) may be configured to revoke or cancel a validity of the policy-based certificate in real-time or in near real-time, to disallow a compromised client 100 from accessing computing resource 200.

For example, if client 100 has been granted a public key policy-based certificate, and then the user has connected (e.g., via an internet browser) to a server that is not within a permitted domain, client 100 (or agent 110 of client 100, as elaborated herein) may send a notification that may include the respective compliance parameter (e.g., an identification of the restricted server). Certificate server 400 (e.g., compliance module 420 of certificate server 400) may subsequently revoke or cancel the validity of the granted certificate.

In some embodiments, certificate server 400 may include a metadata module 430 that may include a certificate revocation list 431. For example, certificate revocation list 431 may include one or more entries, in which a specific certificate may be associated with a respective status of validity. Additionally, or alternatively, certificate revocation list 431 may include a cause for which the specific certificate may have been invalidated or revoked, and/or a timestamp (e.g., in a Coordinated Universal Time (UTC) format) indicating a time at which the certificate may have been revoked or reinstated, as in the example of table 1, below:

TABLE 1

| Certificate ID | Timestamp | Validity | Cause of invalidity |
|---|---|---|---|
| C1 | T1 | Valid | — |
| C2 | T2 | Invalid | CP1 |

In the example of table 1, revocation list 431 may include two entries: In a first entry, certificate C1 may be in a valid status and may have been so since time T1. In a second entry, certificate C2 may be in an invalid status and may have been so since time T2, due to noncompliance of at least compliance parameter 40B CP1.

As shown in the example of table 1, Certificate server 400 may revoke the validity of a granted certificate 40A by marking the certificate as revoked in a respective field in the revocation list 431. Authenticating entity 300 may be configured to query the validity of the certificate from revocation list 431 as part of the authentication of the certificate. If the certificate is marked as revoked on revocation list 431, then authenticating entity 300 may determine that the certificate is invalid and, therefore, may prevent access of client 100 to the required computational resource 200 according to the validity of the policy-based certificate. Invalidation of the certificate may, therefore, disable access of a non-compliant client 100 to the required computational resource 200 by using the certificate as an access factor via authenticating entity 300.

Alternatively, if the continuously and/or repeatedly monitored parameters 40B do comply with rules of the compliance policy after a policy-based certificate has been revoked (e.g., after compliance module 420 has marked a respective field of revocation list 431 as invalid), then certificate server 400 (e.g., compliance module 420 of certificate server 400) may be configured to restore the validity of the policy-based certificate in real-time or near real-time. For example, if a certificate granted to client 100 has been revoked (e.g., due to having a non-compliant version of a software), and then the condition for compliance has been amended (e.g., the software version has been updated to a compliant version), then certificate server 400 may be configured to reinstate the previously revoked certificate (e.g., by updating a respective field in revocation list 431). Pertaining to the example of table 1, certificate server 400 may reinstate previously revoked certificate C2 by amending the content of revocation list 431 as in the example of table 2, below:

TABLE 2

| Certificate ID | Timestamp | Validity | Cause of invalidity |
|---|---|---|---|
| C1 | T1 | Valid | — |
| C2 | T3 | Valid | — |

In the example of table 2, a validity of certificate C2 has been reinstated or revalidated, at the time T3.

Authenticating entity 300 may be configured to consequently enable access of client 100 to the required computational resource 200 according to the restored validity of the policy-based certificate.

According to some embodiments, client computer 100 may include a certificate store or storage 120, configured to maintain or store at least one public key certificate granted by certificate server 400. For example, certificate server 400 may grant or send at least one public key certificate to at least one computational resource 200, according to at least one of: an organizational subordination scheme, a role of a user in an organization, a role of an owner of the device, and the like. Certificate store 120 may be implemented as a storage device (e.g., element 4 or 6 of FIG. 1), and may associate at least one public key certificate with at least one computational resource 200 as known in the art.

Client computer 100 may include a client authentication module or service 130, e.g., a client service, configured to present or provide a certificate from certificate store 120 to authenticating entity 300 in order to gain access to the computational resource 200. Client authentication module 130 may, for example, be implemented as a service or a process, and may be executed on the by one or more processors or controllers (e.g., element 2 of FIG. 1) on client computer 100.

As elaborated herein, certificate server 400 may be associated with (e.g., communicatively connected to) at least one agent module 110. The at least one agent module 110 may be associated with or included in a respective at least one client 100 computing device. For example, agent 110 may be implemented as a software module, and may be executed by a processor of client 100 device. Additionally, or alternatively, agent 110 may be implemented as a software module, a hardware module or any combination thereof, and may be communicatively connected to one or more client 100 computing devices.

According to some embodiments, agent 110 may be configured to gather or obtain data pertaining or relating to one or more compliance parameters 40B (e.g., governance policy parameters, cyber-security parameters, etc.) of at least one client 100 computing device. Additionally, or alternatively, agent 110 may continuously, repeatedly or periodically propagate or send the gathered data to the certificate server 400 for monitoring.

For example, agent module 110 may receive (e.g., from a user) a list including at least one predefined compliance parameter (e.g., a version of an installed software), determine whenever a change has been made to at least one predefined compliance parameter (e.g., the version of software) and propagate the determined change (e.g., via a message over a computer network) as a compliance parameter 40B to certificate server 400 for monitoring.

In some embodiments, agent module 110 may be implemented as a software service or process and may be executed by one or more processors or controllers (e.g., element 2 of FIG. 1) on client computer 100. In alternative embodiments, agent module 110 may be implemented on a separate hardware module (e.g., computing device 1 of FIG. 1) and may be communicatively connected (e.g., via a computer network) to one or more client computers 100.

In some embodiments, agent module 110 may be configured to receive at least one interrupt (e.g., a timing interrupt, a software interrupt, a hardware interrupt, etc.) following any change in a value of a compliance parameter stored on client 100. For example, agent 110 may be configured to receive a software interrupt whenever a value of a system variable (e.g., a system repository variable, such as version of an installed software or hardware) has been changed.

In alternative embodiments, agent module 110 may be configured to repeatedly query or poll the value of one more compliance parameters stored on client 100.

According to some embodiments, agent module 110 may be configured to receive one or more messages 40D from certificate server 400 and may be configured to handle the received one or more messages on client 100. In some embodiments, certificate store or storage 120 may include a revocation list 121 (e.g., such as elaborated herein, in relation to table 1), and agent module 110 may be configured to revoke or restore a status of validity of at least one certificate according to at least one message from certificate server 400.

According to some embodiments of the invention, agent module 110 may receive a granted, policy-based certificate 40A from certificate server 400 and may store policy-based certificate 40A or a reference or pointer thereto in certificate store 120 associated with or included in respective client 100, for the use of the client authentication module 130 (e.g., for authentication of client 100 vis a vis authenticating entity 300).

According to some embodiments of the invention, agent module 110 may be configured to perform at least one of: receive a revocation message from the certificate server and revoke a validity of a respective policy-based certificate in the certificate store; receive a revocation message from the certificate server and remove a respective policy-based certificate from the certificate store; receive a revalidation message from the certificate server and restore the validity of a respective policy-based certificate in the certificate store; and revoke a validity of a policy-based certificate according a policy-based certificate's time limitation, as elaborated herein.

For example, agent module 110 may revoke a validity of a time-limited certificate according the certificate's time limitation. For example, following reception of a time-limited certificate from the certificate server 400, agent module 110 may set up a timing interrupt that will go off when the time has elapsed. When the interrupt is triggered, agent module 110 may revoke the validity of the elapsed policy-based certificate 40A (e.g., by marking the certificate as invalid in revocation list 121) and/or remove the time-limited policy-based certificate 40A from certificate store 120.

In another example, agent module 110 may receive a revocation message 40D from certificate server 400 relating to one or more certificates 40A and may consequently revoke a validity of a respective certificate in the revocation list of certificate store 120.

In another example, agent module 110 may receive a revocation message 40D from certificate server 400 relating to one or more certificates and may consequently remove at least one respective certificate from certificate store 120. In this example, in case authenticating service 300 is compromised (e.g., authenticating service 300 is unable to properly deny access of client 100 to computational resource 200), removal of an invalidated certificate from certificate store 120 may provide an additional defense, by preventing access of client 100 based on an invalidated certificate.

In another example, agent module 110 may receive a revalidation message 40D from certificate server 400, relating to one or more policy-based certificates. Agent module 110 may consequently revalidate at least one respective, previously revoked validity of a certificate in the revocation list 121 of certificate store 120.

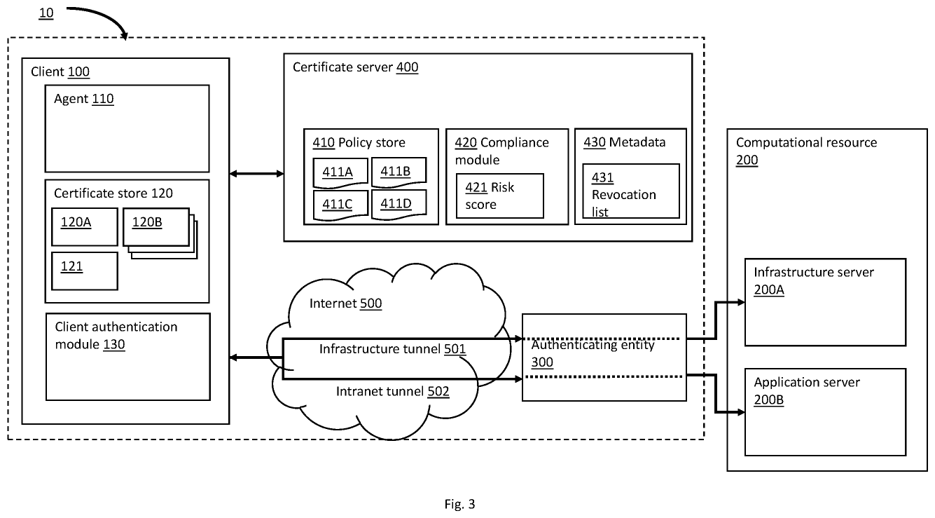

Reference is now made to FIG. 3, which is a block diagram depicting an example of an implementation of a system for managing public key certificates, according to some embodiments.

As in the embodiments depicted in FIG. 2, certificate server 400 may be configured to continuously produce a risk score 421, which may include an overall assessment of risk or “health” state in relation to one or more client computers 100.

In the example depicted in FIG. 3, an authenticating entity or service 300 may facilitate connection of client 100 to computational resource 200 over two Internet-Protocol Secure (IPSec) tunnels, as known in the art.

A first IPSec tunnel may be an infrastructure tunnel 501, facilitating access to core network services (e.g., a Dynamic Host Configuration Protocol (DHCP)) on an infrastructure server 200A. A second IPSec tunnel may be an intranet tunnel, which may be established, for example, after a user logs into client computer 100 and may facilitate access of an authorized client 100 to all authorized resources (e.g., authorized resources inside the corporate network) such as application server 200B.

Both tunnels may be authenticated for example by mutual SSL authentication, based on client SSL certificates that may, for example, pre-exist on client 100 as known in the art.

In some embodiments, agent module 110 may generate a valid client certificate in a machine-level certificate store 120A, to allow authentication of access via the infrastructure tunnel 501, regardless of the client computer's 100 status of compliance. This may enable access of client 100 to infrastructure server 200A as long as a valid agent module is installed therein. In some embodiments, the machine-level certificate may be time limited. In this configuration, un-enrolling or un-installing agent module 110 from client 100 may prevent certificate server 400 from granting or revalidating a certificate for client 100 after the time limit has elapsed. Consequently, authenticating service 300 will deny access of client 100 via infrastructure tunnel 501 to infrastructure server 200A after the time limit has elapsed.

Agent module 110 may receive a user-level, time-limited policy-based certificate 40A from certificate server 400, with a permissible risk score 421 or health state. Agent module 110 may maintain the certificate in one or more user-level certificate stores 120B of client 100, to use as an authentication factor for accessing application server 200B via intranet tunnel 502. The certificate 40A may have a short expiration period, to prohibit malicious users or applications from reusing them even if the agent module 110 is disabled, uninstalled, compromised or unable to communicate with certificate server 400.

As explained above, certificate server 400 may be configured to continuously assess the risk score 421 of a client 100 in relation to its compliance with one or more compliance policies 411. For example, certificate server 400 may score the client 100 according to at least one of an identification of client 100, an identification of a computational resource 200, one or more compliance parameters and one or more compliance rules of compliance policies 411 (e.g., each having a different weight or priority) to produce a risk score 421. If the score reaches a predefined threshold, certificate server 400 may send a revocation message 40D to agent 110, to revoke the validity of the certificate and/or remove the certificate from certificate store 120B. Authenticating service 300 may consequently deny access of client 100 to application server 200B via intranet tunnel 502.

According to some embodiments, if the risk score 421 decreases beneath the predefined threshold, agent module 110 may reinstate or reissue a valid certificate and authenticating service 300 may consequently reenable connection of client 100 to application server 200B via intranet tunnel 502.

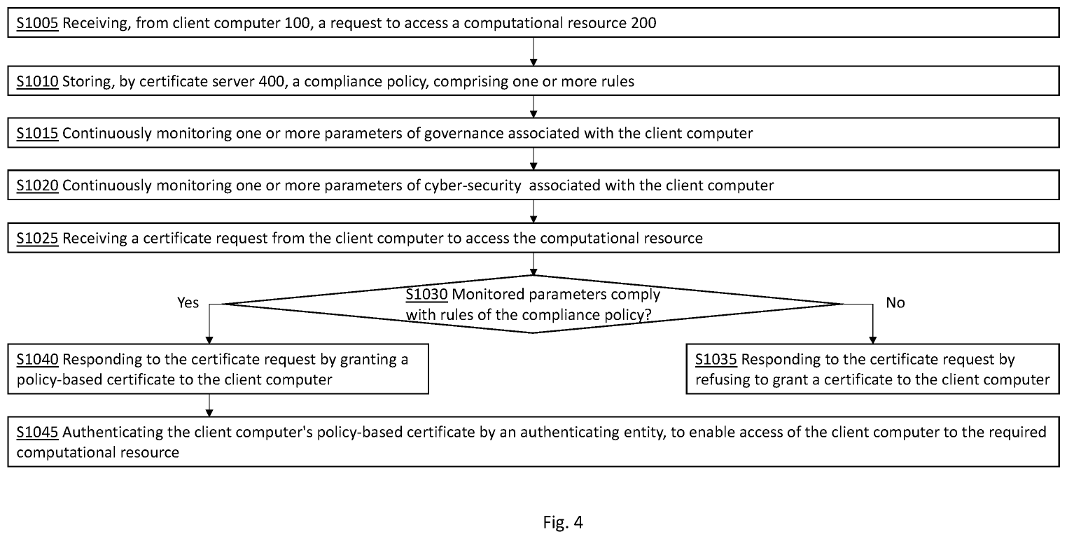

Reference is now made to FIG. 4, which is a flow diagram depicting a method of managing public key certificates by one or more processors, according to some embodiments.

In step S1005, at least one processor or controller (e.g., element 2 of FIG. 1) may receive a request to access a computational resource (e.g., element 200 of FIG. 2) from a client computer (e.g., element 100 of FIG. 2).

In step S1010, a certificate server (e.g., element 400 of FIG. 2) may store a compliance policy, that may include one or more rules. Each rule may for example dictate a condition for granting a policy-based certificate in view of one or more compliance parameters.

As explained above, the term ‘Governance’ is used herein to refer to a policy that may be dictated, for example, by an organization, and may define terms for compliance of client computers that require access to computational resources of the organization. In step S1015, certificate server 400 may continuously monitor one or more parameters of governance associated with the client computer. For example, a parameter of governance may include at least one of: a type of the client computer, the client computer's geo-location, a version of a hardware installed therein, a version of a software installed therein, data relating to previous usage of the client computer, a profile of a current user of the client computer, a role of a current user of the client computer and an owner of the client computer. A governance may include a condition for enabling access to a client according to at least one respective monitored governance parameter. For example, a governance rule relating to a software version may dictate that a certificate will be granted to a client only if the version of the installed software does not precede that of a specific version number.

In step S1020, certificate server 400 may continuously monitor one or more parameters of cyber-security associated with the client computer. For example, a parameter of cyber-security may be an existence of a known threat on client 100, and the respective rule may be to deny a request for access, if the known threat exists on the respective client 100.

In step S1025, certificate server 400 may receive a certificate request from the client computer 100 to access the computational resource 200.

In step S1030, certificate server 400 may check whether the monitored parameters comply with rules of the compliance policy.

In step S1035, if the monitored parameters do not comply with rules of the compliance policy, certificate server 400 may respond to the certificate request by refusing to grant a certificate to the client computer.

In step S1040, if the monitored parameters comply with the rules of the compliance policy, then certificate server 400 may respond to the certificate request by granting a policy-based certificate to the client computer.

In step S1045, the client computer's policy-based certificate may be authenticated by an authenticating entity (e.g., authenticating service 300 of FIG. 3). For example, authenticating entity 300 may verify that the certificate has been issued and signed by the certificate server, and that the current date and time match a start time and an end time that may be included in the certificate, as known in the art. After the certificate is authenticated, a computational resource (e.g., element 200 of FIG. 3) may enable a user of client 100 to access data stored therein. For example, a computational resource (e.g., a server) may perform a process of authorization according to the user's roles and permissions in an organization, as known in the art.

Some embodiments of the present invention may improve a process of accessing computational resources by client computers.

In the current state of the art, a client which may have been compromised or may have moved out of compliance with rules and policies of governance and cyber-security, may retain access to computational resources by using previously granted public-key certificates as authentication factors.

In contrast, some embodiments of the present invention enforce policies of governance and cyber-security by actively controlling the validity and/or availability of previously granted certificates in real time or in near real-time, and thus may prevent access of a compromised client to computational resources shortly after the client may have fallen out of compliance.

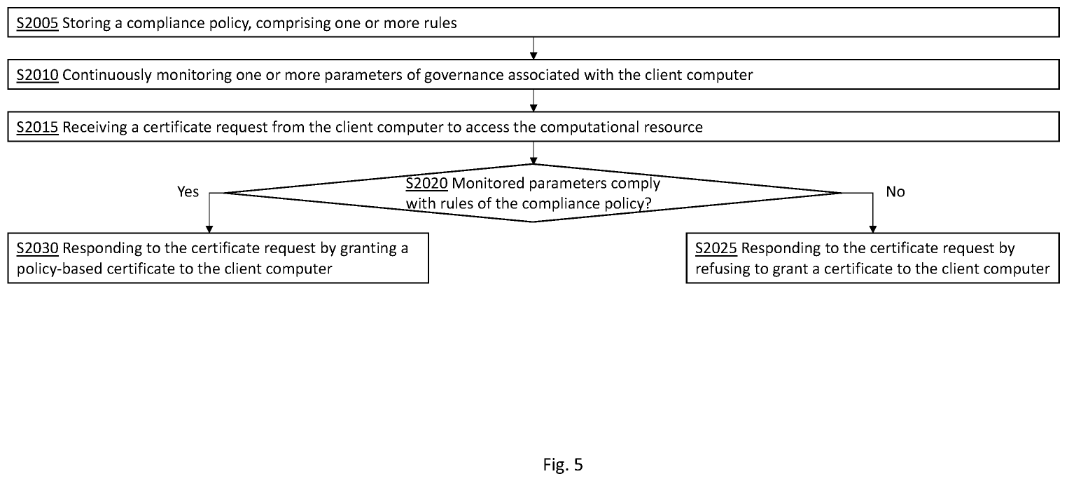

Reference is now made to FIG. 5, which is a flow diagram depicting a method of managing public key certificates by one or more processors, according to some embodiments.

As shown in step S2005, at least one processor or controller (e.g., element 2 of FIG. 1) may store a compliance policy 411 (e.g., elements 411A, 411B, 411C, 411D of FIG. 2) that may include one or more rules which may dictate one or more conditions for granting a policy-based certificate, as elaborated herein.

As shown in step S2010, the at least one processor 2 may continuously and/or repeatedly monitor one or more compliance parameters (e.g., element 40B of FIG. 2) associated with at least one client computer or computing device (e.g., element 100 of FIG. 2).

As shown in step S2015, the at least one processor 2 may receive a certificate request (e.g., element 40C of FIG. 2) from the at least one client 100 computer to access a computational resource (e.g., element 200 of FIG. 2).

As shown in step S2020 and step S2025, if the monitored compliance parameters do not comply with at least one rule of the compliance policy as elaborated herein (e.g., in relation to FIG. 2), then the at least one processor 2 may respond to the certificate request 40C by refusing to grant a certificate to the at least one client computer and/or by not responding to the request 40C at all.

As shown in step S2020 and step S2030, if the monitored compliance parameters 40B comply with the rules of the one or more compliance policies 411, then the at least one processor 2 may respond to the certificate request by granting a policy-based certificate 40A to the at least one client computer.

Some embodiments of the present invention may include a practical application for managing public-key client certificates. Some embodiments of the present invention may provide an improvement over prior methods and systems that manage public-key client certificates by continuously (e.g., repeatedly over time) and dynamically (e.g., in a manner that may be altered over time) monitoring a status of compliance of one or more clients to a set of compliance rules and/or policies, and allow access of the one or more clients to a requested computing resource based on the monitored compliance status.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A certificate server configured to:
store a compliance policy, comprising one or more rules;
continuously monitor one or more compliance parameters associated with at least one client computer;
receive a certificate request from the at least one client computer to access a computational resource;
if the monitored compliance parameters do not comply with at least one rule of the compliance policy, respond to the certificate request by refusing to grant a certificate to the at least one client computer; and
if the monitored compliance parameters comply with the rules of the compliance policy, respond to the certificate request by granting a policy-based certificate to the at least one client computer.

2. The certificate server of claim 1, further configured to: if one or more monitored compliance parameters do not comply with at least one rule of the compliance policy after a policy-based certificate has been granted to the client computer, revoke a validity of the policy-based certificate in real-time or near real time.

3. The certificate server of claim 2, further configured to: if the monitored compliance parameters comply with rules of the compliance policy after a policy-based certificate has been revoked, restore the validity of the policy-based certificate in real time or near real time.

4. The certificate server of claim 1, wherein the compliance policy is selected from a list consisting of:
a governance policy, associated with one or more governance compliance parameters;
a cyber-security policy, associated with one or more cyber-security compliance parameters;
a time-based policy, associated with one or more time-based compliance parameters; and
an implementor-specific policy associated with one or more implementor compliance parameters.

5. The certificate server of claim 4, wherein one or more time-based compliance parameters are time limits, adapted to restrict a validity of the policy-based certificate to a time frame.

6. The certificate server of claim 4, wherein the governance compliance parameters are selected from a list consisting of: a type of a client computer, the client computer's geo-location, a type of hardware installed on the client computer, a version of a hardware installed on the client computer, a software installed on the client computer, a version of a software installed on the client computer, a status of installation of software components on the client computer, data relating to previous usage of the client computer, a profile of a user of the client computer, a role of a user of the client computer, an identification of an owner of the client computer, an enrollment of the client computer in an organization domain, a status of encryption of disk drivers of the client computer, a status of password protection of the client computer, a status of connection to peripheral devices, and a status of a limitation to a number of open communication ports.

7. The certificate server of claim 4, wherein the cyber-security compliance parameters are selected from a list consisting of: a known vulnerability of a client computer, a status of a known cyber threat, an insecure configuration of the client computer, a malicious software installed on the client computer, a protocol used by the client computer, a communication with a compromised entity, a status of received network errors, a status of network activity, and a rogue process executed by the client computer.

8. The certificate server of claim 1, wherein the certificate server is associated with an authenticating entity, configured to authenticate the at least one client computer's policy-based certificate, to enable access of the at least one client computer to the computational resource.

9. The certificate server of claim 1, associated with at least one agent module that is associated with at least one respective client computer, wherein the at least one agent module is configured to:
gather data pertaining to one or more compliance parameters of the at least one client computer; and
continuously propagate the gathered data to the certificate server for monitoring.

10. The certificate server of claim 1, further configured to determine if the monitored compliance parameters comply with rules of compliance policy according to a risk score comprising a weighted sum of individual compliance test results.

11. A system for managing public-key client certificates, comprising a certificate server and an authenticating entity, wherein the certificate server is configured to:
store a compliance policy, comprising one or more rules;
continuously monitor one or more compliance parameters associated with at least one client computer;
receive a certificate request from the at least one client computer to access a computational resource;
if the monitored compliance parameters do not comply with at least one rule of the compliance policy, respond to the certificate request by refusing to grant a certificate to the at least one client computer; and
if the monitored compliance parameters comply with the rules of the compliance policy, respond to the certificate request by granting a policy-based certificate to the at least one client computer,
wherein the authenticating entity is configured to authenticate the client computer's policy-based certificate, to enable access of the client computer to the computational resource.

12. The system of claim 11, wherein the authenticating entity is selected from a list consisting of: an authenticating service, an application service and a network protocol.

13. The system of claim 11, wherein the authenticating entity is further configured to enable access of the at least one client computer to the computational resource based on validity of the policy-based certificate.

14. The system of claim 11, further comprising at least one agent associated with a respective at least one client computer, the agent configured to:
gather data relating to one or more compliance parameters associated with the client computer; and
continuously propagate the gathered data to the certificate server for monitoring.

15. The system of claim 14, wherein the agent is further configured to receive a policy-based certificate from the certificate server and to store the policy-based certificate in a certificate store associated with a respective client computer.

16. The system of claim 15, wherein the agent is further configured to perform at least one of:
receive a revocation message from the certificate server and revoke a validity of a respective policy-based certificate in the certificate store;
receive a revocation message from the certificate server and remove a respective policy-based certificate from the certificate store;
receive a revalidation message from the certificate server and restore the validity of a respective policy-based certificate in the certificate store; and
revoke a validity of a policy-based certificate according a policy-based certificate's time limitation.

17. The system of claim 11, wherein the compliance policy is selected from a list consisting of:
a governance policy, associated with one or more governance compliance parameters;
a cyber-security policy, associated with one or more cyber-security compliance parameters;
a time-based policy, associated with one or more time-based compliance parameters; and
an implementor-specific policy, associated with one or more implementor compliance parameters.

18. A method of managing public-key client certificates by at least one processor, the method comprising:
maintaining a compliance policy comprising one or more rules;
continuously monitoring one or more compliance parameters associated with at least one client computer;
receiving a certificate request from the at least one client computer to access a computational resource;
if the monitored compliance parameters do not comply with at least one rule of the compliance policy, responding to the certificate request by refusing to grant a certificate to the at least one client computer; and
if the monitored compliance parameters comply with the rules of the compliance policy, responding to the certificate request by granting a policy-based certificate to the at least one client computer.

19. The method of claim 18, further comprising authenticating the client computer's policy-based certificate, to enable access of the client computer to the computational resource based on validity of the policy-based certificate.

20. The method of claim 19, wherein the compliance policy is selected from a list consisting of:
a governance policy, associated with one or more governance compliance parameters;
a cyber-security policy, associated with one or more cyber-security compliance parameters;
a time-based policy, associated with one or more time-based compliance parameters; and
an implementor-specific policy, associated with one or more implementor compliance parameters.

21. The method of claim 19, further comprising: if one or more monitored compliance parameters do not comply with at least one rule of the compliance policy after a policy-based certificate has been granted to the client computer, revoking a validity of the policy-based certificate in real-time or near real time.

22. The method of claim 21, further comprising: if the monitored compliance parameters comply with rules of the compliance policy after a policy-based certificate has been revoked, restoring the validity of the policy-based certificate in real time or near real time.
